(19) United States
(12) Patent Application Publication
(10) Pub. No.: US 2004/0250404 A1
(43) Pub. Date: Dec. 16, 2004

(54) Process for press forming metal tubes

(76) Inventor: Timothy J. Cripsey, Rochester, MI (US)

Correspondence Address: HARNESS, DICKEY & PIERCE, P.L.C., P.O. BOX 828, BLOOMFIELD HILLS, MI, 48303, US

(21) Appl. No.: 10/757,967

(22) Filed: Jan. 14, 2004

Related U.S. Application Data
(60) Provisional application No. 60/439,907, filed on Jan. 14, 2003.

(51) Int. Cl. B21C 37/06; B23P 19/04

(52) U.S. Cl. 29/460; 29/527.2; 72/368

(57) ABSTRACT

Sub-blanks having different thicknesses and/or different materials are joined together along a joint line or boundary line. The joint line can have an axial directional component and/or a radial directional component. The blank is formed into a U-shaped structure with two substantially parallel arms and the arms can be overbent toward each other by a distance that varies along the axial length of the U-shaped member. The U-shaped member can be subjected to a press forming operation to form a substantially tubular member. The substantially tubular member can have a non-circular cross-sectional shape. A step can be formed at the joint line as a result of different thickness sub-blanks. The step is placed in a press forming die facing outwardly so that the step is reduced during the press forming operation.

### CROSS-REFERENCE TO RELATED APPLICATIONS

This application claims the benefit of U.S. Provisional Application No. 60/439,907, filed on Jan. 14, 2003. The disclosure of the above application is incorporated herein by reference.

### FIELD OF THE INVENTION

The present invention relates to a process for manufacturing tubular members; particularly, to such a process including a press forming operation.

### BACKGROUND OF THE INVENTION

Tubular members have historically been made by continuous roll forming of a flat material into a tubular member having a circular cross-section. These tubular members can then be cut into sections or pipes of desired length. In order to provide tubular members with circular cross-sections that vary in diameter along the axial length, various pipe sections have been welded together after formation of these tubular members.

More recently, tubular members have been formed using various press forming processes. The use of press forming processes have enabled more flexibility in manufacturing tubular members having cross-sections which vary along their axial length. Additional cross-sectional variation along the axial length has been achieved by subjecting the tubular members to a subsequent hydroforming operation. There remains a desire, however, for tubular manufacturing processes which can enable the manufacture of improved tubular members, which can enable increased variability in the manufacture of tubular members, which can enable costs reductions and/or which can enable other benefits.

### SUMMARY OF INVENTIVE ASPECTS

In one inventive aspect of the present disclosure a process of making a tubular member is provided. The process includes forming a first sub-blank having a thickness and a second sub-blank having different thickness. The first and second sub-blanks are joined together along a joint line to create a flat blank having a step at the joint between first and second sub-blanks and opposing side edges. The blank is located between two press forming die halves so that the step faces outwardly toward the die halves. The two die halves are pressed together to form the blank into a tubular member, thereby reducing the step at the joint.

In another inventive aspect of the present disclosure a process of making a tubular member is provided. The process includes forming a first sub-blank and a second sub-blank and joining the first and second sub-blanks together along a joint line having an axial directional component to create a flat blank having opposing side edges. The opposing side edges of the flat blank are joined together to form a tubular member.

In another inventive aspect of the present disclosure a process of making a tubular member is provided. The process includes creating a flat blank comprising a first portion adjoining a second portion along a boundary line, wherein at least one of a material and a thickness of the first portion is different from that of the second portion, and wherein the boundary line has both an axial directional component and a radial directional component. The blank is formed into a tubular member by joining the opposing side edges of the blank together.

In another inventive aspect of the present disclosure a process of making a tubular member is provided. The process includes creating a flat blank having a tendency to spring back that varies along the axial length of the flat blank. A central axial force is applied to the blank to create a U-shaped structure with two substantially parallel arms, each of the arms having a distal edge. Another force is applied to move the distal edges of the arms together by a distance, wherein the distance varies along the axial length of the U-shaped structure.

In another inventive aspect of the present disclosure a process of making a tubular member is provided. The process includes forming a substantially tubular member having an initial cross-sectional shape. The substantially tubular member is located in a press forming die between two female die halves which together define a mold cavity with a cross-sectional shape that is different from the initial cross-sectional shape and that is not substantially circular. The two female die halves are moved together to cause the tubular member to take on the cross-sectional shape of the mold cavity.

In another inventive aspect of the present disclosure a process of making a tubular member is provided. The process includes forming a substantially U-shaped member and locating the substantially U-shaped member in a press forming die between two female die halves which together define a mold cavity with a cross-sectional shape that is not substantially circular. The two female die halves are moved together to cause the tubular member to take on the cross-sectional shape of the mold cavity.

In another inventive aspect of the present disclosure a process of making a tubular member is provided. The process includes forming a first sub-blank and a second sub-blank and joining the first and second sub-blanks together along an arcuate joint line to create a flat blank having opposing side edges. The opposing side edges of the flat blank are joined together to form a tubular member.

In another inventive aspect of the present disclosure a process of making a tubular member is provided. The process includes forming a first sub-blank from a flat sheet of a material and forming a second sub-blank from a flat sheet of a different material. The first and second sub-blanks are joined together along a joint line to create a flat blank having opposing side edges. The flat blank is press formed into a substantially U-shaped member and the substantially U-shaped member is transformed into a substantially tubular member. The opposing side edges of the substantially tubular member are joined together to form a tubular member.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a top plan view of an exemplary blank formed in accordance with an exemplary process of the present invention;

FIG. 2 is a top plan view of an alternative exemplary blank formed in accordance with an exemplary process of the present invention;

FIG. 3 is a top plan view of another exemplary blank formed in accordance with an exemplary process of the present invention;

FIG. 4 is a top plan view of an additional exemplary blank formed in accordance with an exemplary process of the present invention;

FIG. 5 is a greatly enlarged fragmentary perspective view of a weld joint line at an opposing edge of the blank of FIG. 3;

FIG. 6 is a side elevation illustration of a U-forming operation, including a female die half and a male die half;

FIG. 7 is a side elevation illustration of an overbending operation;

FIG. 8 is an enlarged perspective illustration showing an embodiment of a female die half for use in the overbending operation;

FIG. 9 is an end elevation illustration with the substantially U-shaped structure located within the mold cavity between two female die halves;

FIG. 10 is an end elevation view similar to FIG. 9, but with the mold halves pressed together;

FIG. 11 is a perspective view of a substantially tubular member;

FIG. 12 is a perspective view of the substantially tubular member of FIG. 11 undergoing a welding operation; and

FIG. 13 is an end view illustration similar to FIG. 10, wherein the mold cavity has a non-circular cross-section.

### DESCRIPTION OF VARIOUS PREFERRED EMBODIMENTS

The following description of the preferred embodiment(s) is merely exemplary in nature and is in no way intended to limit the invention, its application, or uses. For example, although each of the substantially U-shaped member forming operations and other substantially tubular shaped member forming operations are disclosed herein as press forming operations, in certain instances one or more of these operations may be replaced by a roll forming operation.

One exemplary process generally includes creating a flat blank, forming the flat blank into a generally U-shaped structure, forming the generally U-shaped structure into a generally tubular structure with a small longitudinal gap between the distal ends of the blank, and joining the distal edges together to complete the tubular structure. As used herein, “tubular” describes a member that has a cross-section defined by a wall that extends completely around a 360° circumference, regardless of the circumferential or peripheral shape of the member. A tubular member may simultaneously have additional cross-sections which, for example, intersect apertures in the tubular member and, therefore, do not provide a complete 360° wall. Similarly, as used herein “U-shaped” structures include structures with a smooth curved radius at the base and structures with other shaped bases.

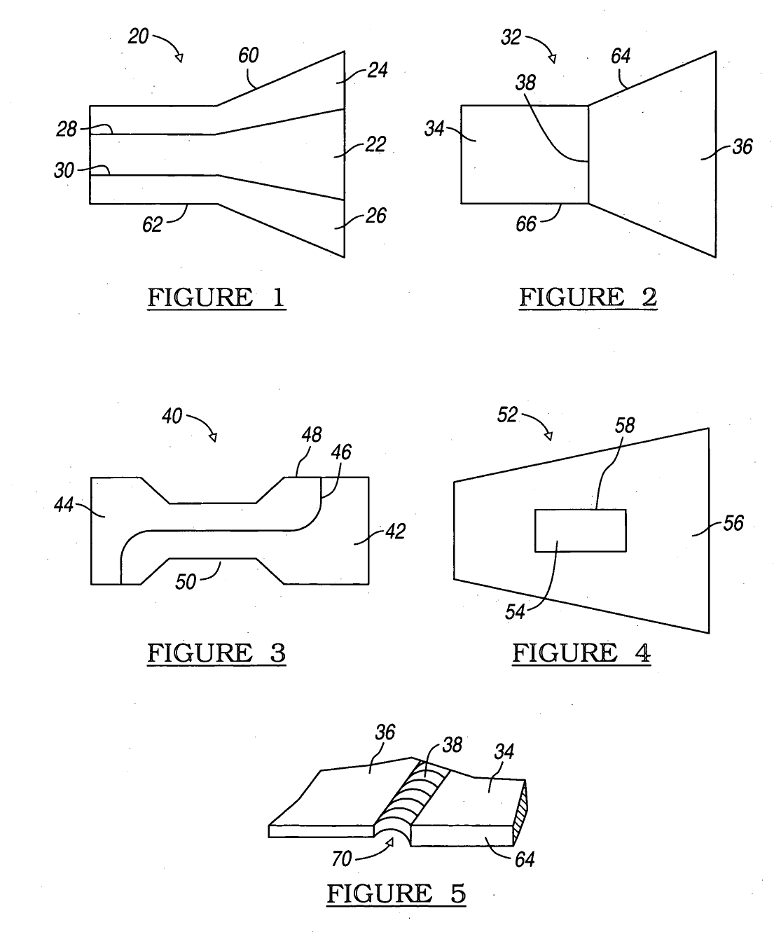

FIGS. 1 through 4 illustrate various flat blanks that may alternatively be created as part of the process. Referring to FIG. 1, this exemplary flat blank 20 is comprised of a centrally located sub-blank 22 that has a somewhat rectangular shape. Along each side of the centrally located sub-blank 22 are additional laterally located sub-blanks 24, 26. Each of these lateral sub-blanks 24, 26 are identical and have a generally rectangular portion and a somewhat trapezoidal portion. Each of the sub-blanks 22, 24, 26 is stamped or otherwise formed from a flat sheet of metal.

Each of the lateral sub-blanks 24, 26 is then joined to the central sub-blank 22 along a joint line 28, 30, respectively. The sub-blanks can be joined together by a welding operation that is suitable for the material, including laser welding, gas metal arc welding, high frequency welding, mash seam welding, or the like. Each joint line 28, 30 provides a boundary line between various portions of the flat blank 20. These joint lines 28, 30 or boundary lines have an axial directional component. In other words, the joint lines 28, 30 or boundary lines extend in a direction that is not simply perpendicular to the axis of blank 20 and/or to the central axis of the subsequently formed tubular member 220. In fact, in this example, the joint lines 28, 30 or boundary lines extend in a direction that is generally parallel to the axis of blank 20 and/or to the axis of the formed tubular member 220.

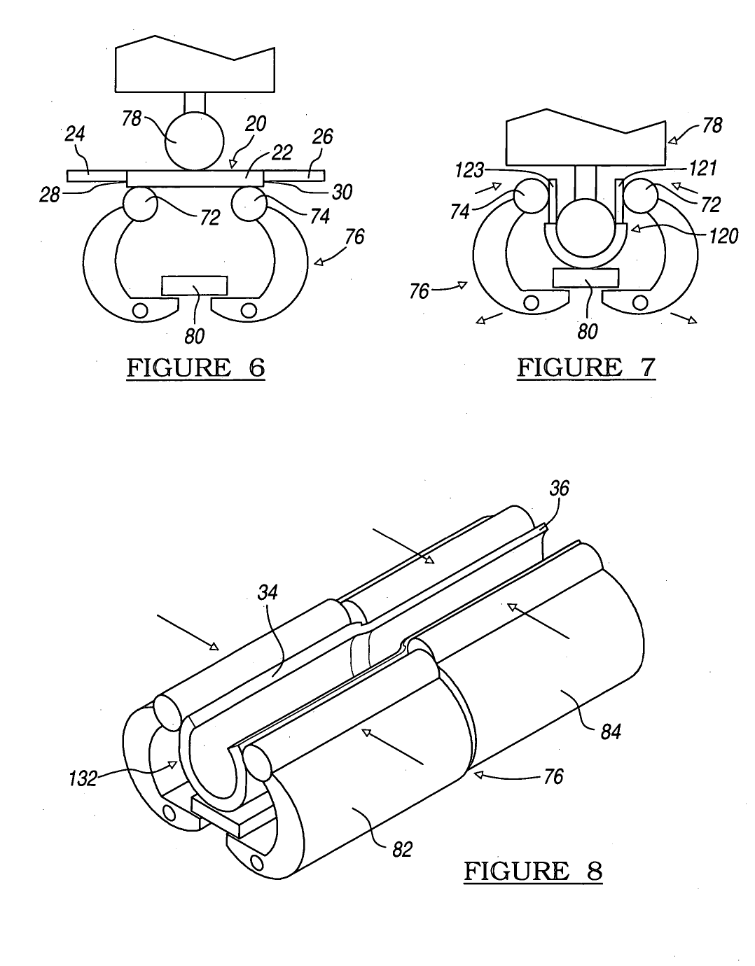

As indicated above, the joint lines 28, 30 or boundary lines separate the flat blank 20 into various portions. The portion of the flat blank 20 corresponding to the central sub-blank 22 is formed from a relatively thick material. In addition, the portions of the flat blank 20 corresponding to the lateral sub-blanks 24, 26 are made from the same material as that of the central sub-blank 22 portion, but are relatively thin in comparison thereto. Thus, a step portion is provided at each of the joint lines 28, 30 or boundary lines as seen in FIG. 6. Alternatively, the various portions 22, 24, 26 may be formed by rolling a single sheet material into various thickness portions.

Referring to FIG. 2, an alternative exemplary flat blank 32 is created that is similarly formed from two sub-blanks 34, 36 that are stamped or otherwise cut from a flat sheet of material. In this case, a substantially rectangular sub-blank 34 is cut from a sheet material that is relatively thick. A substantially trapezoidal sub-blank 36 is cut from a sheet of material that is relatively thin. These sub-blanks are subsequently joined together by welding or another appropriate process along a joint line 38 or boundary line to form the flat blank 32.

The joint line 38 or boundary line has only a radial directional component and no axial directional component. In other words, the joint line 38 or boundary line extends in a direction that is perpendicular to the axis of blank 32 and/or to the axis of the subsequently formed tubular member. This joint line 38 or boundary line separates the flat blank 32 into two portions. Since the portion of the flat blank 32 corresponding to the rectangular sub-blank 34 is formed from a relatively thin material and the trapezoidal sub-blank 36 portion is relatively thick in comparison thereto, a step is formed at the joint line 38 or boundary line similar to that discussed above with respect to the embodiment of FIG. 1.

Referring to FIG. 3, another alternative exemplary flat blank 40 is created. In this case, the flat blank 40 includes a portion 42 with material that has been treated and/or surface coated and a portion 44 with material which has not. Thus, as used herein, each portion 42, 44 is made of a material that is different from the other portion. In this case, the flat blank 40 is stamped or otherwise cut from a flat sheet of material. The surface coating and/or treating can be provided to the treated portion 42 either before or after the cutting operation.

As an alternative, the flat blank 40 can be formed from two different sub-blanks corresponding to the two portions 42, 44 of the flat blank 40. The two sub-blanks 42, 44 are joined together by welding, for example, as discussed above. Examples of different materials that can be used to form the sub-blanks 42, 44 include mild strength steel, high strength steel, stainless steel, galvanized steel and annealed steel.

A boundary line 46 is illustrated that demarks the boundary between the treated portion 42 and the untreated portion 44. In this case, the boundary line 46 between the portions of the flat blank 40 has an arcuate shape, and therefore, includes an axial directional component. In fact, the boundary line 46 includes a segment that is substantially parallel to the axial direction. In addition, the boundary line 46 includes segments that are substantially perpendicular to the axial direction. Furthermore, the boundary line 46 intersects both opposing side edges 48, 50 of the flat blank 40.

Referring to FIG. 4, an additional exemplary flat blank 52 is illustrated which has a sub-blank 54 insert that is formed from a material that is different and which has a different thickness than the surrounding sub-blank 56 material. As with the flat blank 20 of FIG. 1 and the flat blank 32 of FIG. 2, this flat blank 52 is comprised of two sub-blanks 54, 56 that are joined together along a joint line 58 or boundary line as discussed above. As an alternative, the material of sub-blank 56 may not be removed in the area of the sub-blank 54. Instead, sub-blank 54 can be welded or otherwise joined to the surface of the sub-blank 56 to create the thicker portion.

The joint line 58 or boundary line has both an axial directional component and a radial directional component. In fact, the joint line 58 or boundary line includes two segments that are substantially parallel to the axial direction. In addition, the joint line 58 or boundary line includes two segments that are substantially perpendicular to the axial direction.

Referring to the blank of FIG. 1 as representative, the opposing edges 60, 62 of the flat blank 20 are optionally provided with an angle so that the opposing side edges 60, 62 are substantially parallel to each other during the press forming operation as discussed below. The angle can be provided on the opposing edges 60, 62 of the blank 20 by a shearing operation or by a skiving operation. The skiving operation generally results in the removal of significantly less material than the shearing operation, which can save meaningful material costs.

Referring to FIG. 5, an enlarged fragmentary perspective view of the joint line 38 at the intersection with one of the opposing side edges 66 of the flat blank 32 of FIG. 2 is illustrated. It can be seen that a material gap 70 often results when at this termination of a weld line. It is desirable to remove sufficient material along the opposing edge 64 that any material gap 70 at the joint line 38 is removed as a result of the operation to provide an angled edge along the opposing side edges 64, 66 of the flat blank 32.

Referring to FIG. 6 and FIG. 7, this exemplary process involves locating the flat blank 20 over a pair of spaced apart rollers 72, 74 forming part of a female die half 76 and subjecting the flat blank 20 to a central axial force provided by the downward motion of a male die half 78. The flat blank 20 is located so that the step created at the joint lines 28, 30 by differences in thickness between various portions 22, 24, 26 of the flat blank 20 face away from the male die half 78 and toward the female die half 76 or the outward side of the U-shaped member 120 into which the flat blank 20 is being formed.

As seen in FIG. 7, male die half 78 moves downwardly, forcing the flat blank 20 against the rollers 72, 74 of the female die half 76. As the blank 20 contacts the bottom 80 of the female die half 76, the rollers 72, 74 are pivoted inwardly to overbend the blank 20 more than 180 degrees. This overbending operation helps insure that the blank 20 remains bent at least about 180 degrees upon being removed from the female die half 76, despite the springiness of the material (i.e., the tendency of the material to spring back towards a flatter shape). Thus, when the blank 20 is removed from the female die half it will remain in a generally U-shape having substantially parallel arms 121, 123. In this manner, the flat blank 20 is formed into a generally U-shaped member 120.

Referring to FIG. 8, when, for example, the substantially U-shaped member varies in thickness and/or stiffness along its axial length, the tendency of the substantially U-shaped member to spring back after a forming operation can also vary along its axial length. In instances where the tendency of the substantially U-shaped member to spring back varies along its axial length, it may be desirable to apply different amounts of overbending along its length.

Referring to the blank 32 of FIG. 2 as representative in this regard, the female die half 76 includes a first section 82 that moves the arms of the inwardly toward each other a relative small distance along the length of the substantially U-shaped member 132 which corresponds to the thicker portion 34 of the blank. The female die half 76 also includes a second section 84 that moves the arms 133, 135 inwardly toward each other a relative large distance which corresponds to the thinner portion 36 of the blank 32. Thus, although the thinner portion 36 has a tendency to spring back further than that of the thicker or stiffer portion 34, the two portions will be substantially aligned after being subjected to this overbending operation and removed from the female die half 76.

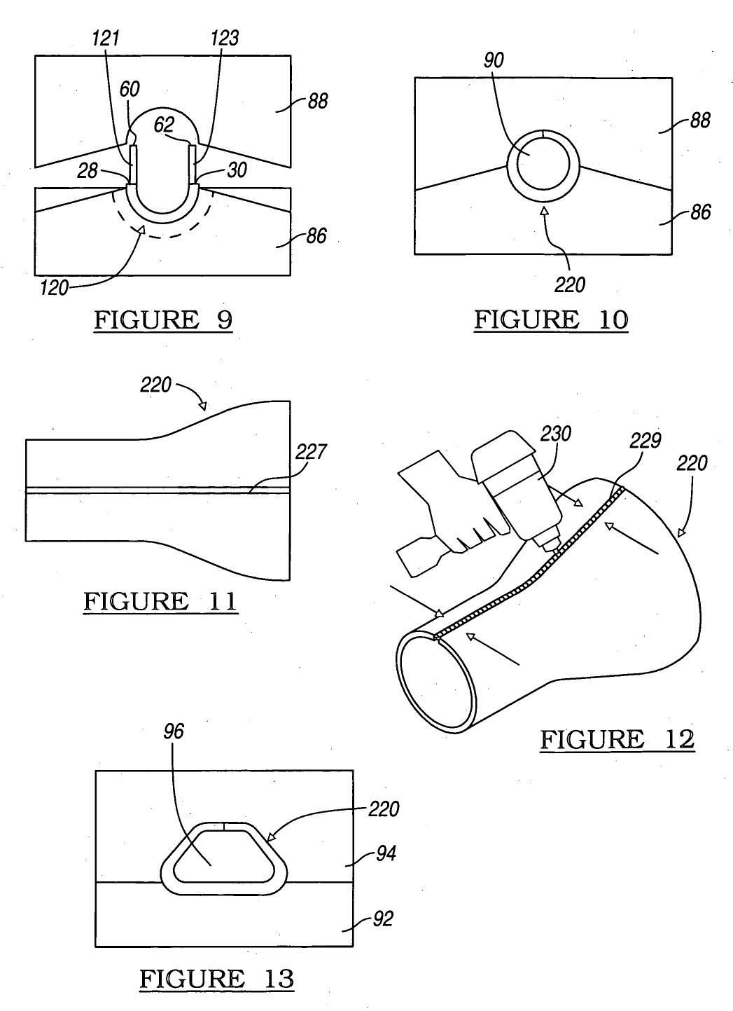

Referring to FIGS. 9 and 10, the U-shaped member 120 is placed in the mold cavity between two female die halves 86, 88 and subjected to a press forming operation. In an alternative embodiment, the lower female die half 86 may be the same female die half 76 as used in the previous U-forming operation. The two female die halves 86, 88 form a mold cavity therein 90. During the press forming operation the two die halves 86, 88 are pressed together. As the die halves 86, 88 are moved toward each other the distal ends of the arms 121, 123 of the substantially U-shaped member 120, which correspond to the opposing side edges 60, 62 of the flat blank 20, come into contact with each other.

Thus, the substantially U-shaped member 120 becomes a substantially tubular member 220 and the arms 121, 123 press against each other to cause the substantially tubular member 220 to resist compression and take on the shape of the mold cavity 90. In addition, this causes the material around the step at the joint lines 28, 30 to move outwardly, creating a relatively smooth transition between the thicker portions 22 and the thinner portions 24, 26 of the substantially tubular member 120. This can be particularly beneficial, for example, when internal mandrels are used in subsequent forming operations.

Referring to FIG. 11, the substantially tubular member 220 is removed from the female die halves 86, 88 and has a small gap 227 along its entire axial length where the distal ends of the arms 121, 123 have been brought together. As seen in FIG. 12, the gap 227 is closed by a clamping operation illustrated by the opposing arrows. The gap 227 can be oriented by using a locating knife (not shown) that is removed from the gap 227 as the substantially tubular shaped member 220 is clamped in place. Once clamped, the distal ends of the arms 121, 123, which correspond to the opposing side edges 60, 62 of the flat blank 20, are welded or otherwise appropriately joined together along joint line 229 as illustrated in FIG. 12. Thereafter, the tubular member 220 may be subjected to a subsequent press forming operation. For example, the tubular member 220 may be subjected to a hydroforming operation.

Referring to FIG. 13, the welded tubular shaped member 220 may alternatively be subjected to a subsequent press forming operation. In this case, the welded tubular member 220 is again placed within a die having two female die halves 92, 94. As the die halves 92, 94 are pressed together, the tubular member 220 takes on the shape of the mold cavity 96 female die 92, 94. Thus, in this case, a substantially U-shaped member 120 is press formed into a substantially tubular member 220 having an initial cross-sectional shape. The axial gap 227 can then be welded. The substantially tubular member 220 is subjected to a further press forming operation using a mold cavity 96 that has a different, non-circular cross-sectional shape.

As another alternative, the substantially U-shaped member 120 can be directly formed into a substantially tubular member 220 having a non-circular cross-sectional shape. In this case, the female die halves 86, 88 of FIGS. 9 and 10 in which the substantially U-shaped member 120 is transformed into the substantially tubular member 220 can have a mold cavity 96 with a non-circular cross-section. For example, these female die halves 86, 88 can be replaced with the female die halves 92, 94 of FIG. 13 having a mold cavity 96 with a non-circular cross-section shape.

In either case, the non-circular cross-sectional shape can be defined by more than two radii, each having a different dimension. Alternatively, the different cross-sectional shape is defined by at least three radii separated from each other. At least two of the three radii can have a substantially identical dimension. A portion of the cross-section defined by each of the three radii can be separated from the other portions by another radiused portion of the cross-section, or by a substantially straight portion of the cross-section, or by both another radiused portion and a substantially straight portion.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A process of making a tubular member comprising:
a. forming a first sub-blank having a thickness and a second sub-blank having different thickness;
b. joining the first and second sub-blanks together along a joint line to create a flat blank having a step at the joint between first and second sub-blanks and opposing side edges;
c. locating the flat blank between two press forming die halves so that the step faces outwardly toward the die halves; and
d. pressing the two die halves together to form the flat blank into a substantially tubular member, thereby reducing the step at the joint.

2. A process of making a tubular member according to claim 1, wherein the substantially tubular member has a cross-section that varies along an axial length of the tubular member.

3. A process of making a tubular member according to claim 1, wherein the joint line has an axial directional component.

4. A process of making a tubular member according to claim 1, wherein the joint line has a radial directional component.

5. A process of making a tubular member according to claim 2, wherein the joint line his both an axial directional component and a radial directional component.

6. A process of making a tubular member comprising:
a. forming a first sub-blank and a second sub-blank;
b. joining the first and second sub-blanks together along a joint line having an axial directional component to create a flat blank having opposing side edges; and
c. joining the opposing side edges of the flat blank together to form a tubular member.

7. A process of making a tubular member according to claim 6, wherein the tubular member has a cross-section that varies along an axial length of the tubular member.

8. A process of making a tubular member according to claim 6, wherein the first and second sub-blanks differ from one another in one of thickness or material.

9. A process of making a tubular member according to claim 6, wherein the joint line further has a radial directional component.

10. A process of making a tubular member according to claim 6, further comprising press forming the flat blank between two female die halves.

11. A process of making a tubular member comprising:
a. creating a flat blank comprising a first portion adjoining a second portion along a boundary line, wherein at least one of a material and a thickness of the first portion is different from that of the second portion, and wherein the boundary line has both an axial directional component and a radial directional component; and
b. forming the blank into a tubular member by joining the opposing side edges of the blank together.

12. A process of making a tubular member according to claim 11, wherein forming the blank into a tubular member further comprises forming the flat blank into a substantially U-shaped member, and press forming the substantially U-shaped member into a substantially tubular member.

13. A process of making a tubular member according to claim 12, wherein the substantially tubular member has a cross-section that varies along an axial length of the substantially tubular member.

14. A process of making a tubular member according to claim 11, wherein the boundary line has an arcuate shape.

15. A process of making a tubular member according to claim 11, wherein the material of the first portion is different from that of the second portion, and the material is made different by applying a coating or treating operation to the first portion of the flat blank.

16. A process of making a tubular member comprising:
a. creating a flat blank having a tendency to spring back that varies along the axial length of the flat blank;
b. applying a central axial force to the blank to create a substantially U-shaped structure with two substantially parallel arms, each of the arms having a distal edge; and
c. applying a force to move the distal edges of the arms together by a distance, wherein the distance varies along the axial length of the substantially U-shaped member.

17. A process of making a tubular member according to claim 16, further comprising press forming the substantially U-shaped member into a substantially tubular member.

18. A process of making a tubular member according to claim 17, wherein the substantially tubular member has a cross-section that varies along an axial length of the substantially tubular member.

19. A process of making a tubular member according to claim 16, wherein creating the flat blank further comprises joining a sub-blank having a thickness to another sub-blank having a different thickness to provide a flat blank with a thickness that varies along its axial length.

20. A process of making a tubular member according to claim 16 wherein creating the flat blank includes causing a portion of the flat blank to be made of a material and another portion of the flat blank to be made of a different material.

21. A process of making a tubular member comprising:
a. forming a substantially tubular member having an initial cross-sectional shape;
b. locating the substantially tubular member in a press forming die between two female die halves which together define a mold cavity with a cross-sectional shape that is different from the initial cross-sectional shape and that is not substantially circular; and
c. moving the two female die halves together to cause the tubular member to take on the cross-sectional shape of the mold cavity.

22. A process of making a tubular member according to claim 21, wherein the forming a substantially tubular member further comprises forming a flat blank into a substantially U-shaped member and press forming the substantially U-shaped member into the substantially tubular member.

23. A process of making a tubular member according to claim 21, wherein the different cross-sectional shape is defined by more than two radii, each having a different dimension.

24. A process of making a tubular member according to claim 21, wherein the different cross-sectional shape is defined by at least three radii separated from each other.

25. A process of making a tubular member according to claim 24, wherein at least two of the at least three radii have substantially identical dimensions.

26. A process of making a tubular member according to claim 24, wherein a portion of the cross-sectional shape that is defined by each of the three radii, respectively, is separated from each other by another radiused portion of the cross-sectional shape, or by a substantially straight portion of the cross-sectional shape, or by both another radiused portion and a substantially straight portion.

27. A process of making a tubular member comprising:
a. forming a substantially U-shaped member;
b. locating the substantially U-shaped member in a press forming die between two female die halves which together define a mold cavity with a cross-sectional shape that is not substantially circular; and
c. moving the two female die halves together to cause the tubular member to take on the cross-sectional shape of the mold cavity.

28. A process of making a tubular member according to claim 27, wherein the cross-sectional shape is defined by more than two radii, each having a different dimension.

29. A process of making a tubular member according to claim 27, wherein the cross-sectional shape is defined by at least three radii separated from each other.

30. A process of making a tubular member according to claim 29, wherein at least two of the at least three radii have substantially identical dimensions.

31. A process of making a tubular member according to claim 29, wherein a portion of the cross-sectional shape that is defined by each of the three radii, respectively, is separated from each other by another radiused portion of the cross-section, or by a substantially straight portion of the cross-section, or by both another radiused portion and a substantially straight portion.

32. A process of making a tubular member comprising:
a. forming a first sub-blank and a second sub-blank;
b. joining the first and second sub-blanks together along an arcuate joint line to create a flat blank having opposing side edges; and
c. joining the opposing side edges of the flat blank together to form a tubular member.

33. A process of making a tubular member according to claim 32, wherein the tubular member has a cross-section that varies along an axial length of the tubular member.

34. A process of making a tubular member according to claim 32, wherein the first and second sub-blanks differ from one another in one of thickness or material.

35. A process of making a tubular member according to claim 32, further comprising press forming the flat blank between two female die halves.

36. A process of making a tubular member according to claim 32, wherein joining the first and second sub-blanks together comprises a welding operation.

37. A process of making a tubular member comprising:
a. forming a first sub-blank from a flat sheet of a material;
b. forming a second sub-blank from a flat sheet of a different material;
c. joining the first and second sub-blanks together along a joint line to create a flat blank having opposing side edges;
d. press forming the flat blank into a substantially U-shaped member;
e. press forming the substantially U-shaped member into a substantially tubular member; and
f. joining the opposing side edges of the substantially tubular member together to form a tubular member.

38. A process of making a tubular member according to claim 37, wherein the tubular member has a cross-section that varies along an axial length of the tubular member.

39. A process of making a tubular member according to claim 37, wherein joining the first and second sub-blanks together comprises a welding operation.

40. A process of making a tubular member according to claim 39, wherein joining the opposing side edges comprises a welding operation.
